(19) United States
(12) Patent Application Publication
(10) Pub. No.: US 2025/0247337 A1
(43) Pub. Date: Jul. 31, 2025

(54) NETWORK MANAGEMENT FOR TELEMETRY DATA

(71) Applicant: Intel Corporation, Santa Clara, CA (US)

(72) Inventors: Gurpreet Singh KALSI, Portland, OR (US); Kartik LAKHOTIA, San Jose, CA (US); Hossein FARROKHBAKHT, Toronto (CA); Fabio CHECCONI, Fremont, CA (US); Fabrizio PETRINI, Menlo Park, CA (US)

(21) Appl. No.: 19/081,946

(22) Filed: Mar. 17, 2025

(51) Int. Cl. H04L 47/76; H04L 47/50; H04L 49/109

(52) U.S. Cl. CPC H04L 47/76; H04L 47/50; H04L 49/109

(57) ABSTRACT

Examples described herein relate to a forwarding element. In some examples, a circuitry, in the forwarding element, is to: receive telemetry data; cause storage of the telemetry data in a buffer; and forward the telemetry data to a network device. In some examples, bandwidth and buffer space in the buffer are exclusively allocated for forwarding the telemetry data and wherein the telemetry data comprises at least one of: management commands, device error reporting data, device performance data, device error data, or device debug data.

Operating a large-scale system (e.g., supercomputer, datacenter, etc.) can be a challenging task as failures can arise at a multitude of different devices or connections. A system reports debug and telemetry information for different compute nodes, storage systems, network interface devices, power delivery, and so forth. Failures in the system can cause system downtime, which can reduce capability to provide services to customers. Telemetry data can identify sources of error in the system and the telemetry data can be used to diagnose and correct malfunctioning devices or to adjust configurations of the system. A volume of telemetry data increases as the number of devices in a system increases, and with rising error rates due to advanced packaging and complex silicon development flows.

### BRIEF DESCRIPTION OF THE DRAWINGS

FIG. 1 depicts an example forwarding element.

FIG. 2 depicts an example network.

FIG. 3 depicts an example network.

FIG. 4 depicts an example of configurations of a forwarding element.

FIG. 5 depicts an example of queue allocation.

FIG. 6 depicts an example process.

FIG. 7 depicts an example computing system.

### DETAILED DESCRIPTION

At least to attempt to reduce a latency of delivery of telemetry data used at least for system configuration and identifying and correcting malfunctioning devices, various examples provide a network for delivery of telemetry data. One or more management nodes in a system can collect information on the operation and/or performance of the nodes in the network from telemetry data transmitted by computing platforms or network interface devices such as forwarding elements. For example, telemetry data can include at least: a heartbeat indicator (e.g., device is active or inactive), error summarization, processor performance data, power delivery state (e.g., power supply is operational or compromised), network interface device state, forwarding element congestion indicators, or other information. To provide the network for delivery of telemetry data, various examples can configure forwarding element port bandwidth, buffer space, egress packet arbitration to prioritize delivery of telemetry data and transmit commands from management nodes to one or more devices. A data center administrator or system orchestrator can dynamically configure resources of the forwarding element to scale up (increase) or scale down (decrease) with the volume of telemetry data. For example, if an amount of transmitted telemetry data rises, resources are allocated to transmit the telemetry data can increase or if an amount of transmitted telemetry data falls, and resources allocated to transmit the telemetry data can be available for other uses. By accessing the telemetry data, an orchestrator or administrator can debug the system and perform corrective actions such as increasing hardware resources, diverting packet traffic, replacing hardware devices, modifying executed software or firmware, or others. In-band telemetry reporting can partition system resources between user and management traffic and dynamically reallocate resources between user and management traffic.

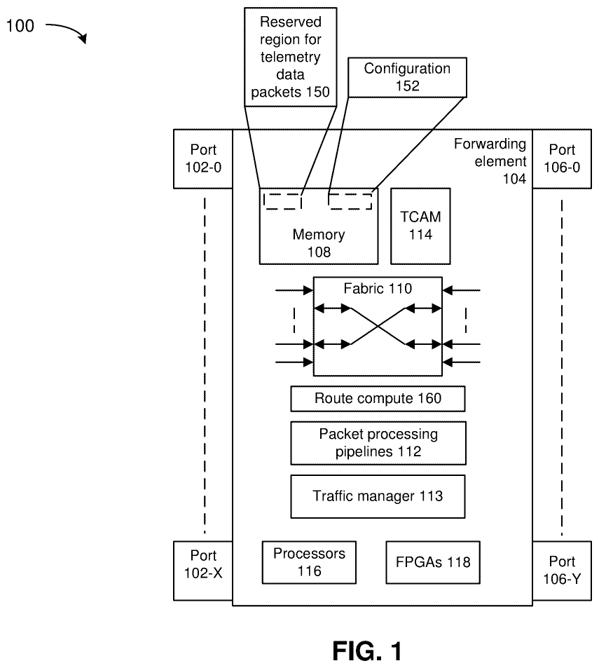

FIG. 1 depicts an example forwarding element. Various examples of forwarding element system 100 can be used in a network on chip (NoC) to perform operations described herein to cause forward telemetry data and management commands. A NoC can include forwarding elements, network interface devices, links, and controllers. However, forwarding elements can be part of a mesh or off-chip network (e.g., Ethernet local area network (LAN) or wide area network (WAN)).

Forwarding element circuitry 104 can be communicatively coupled to one or more of ingress ports 102-0 to 102-X by interface circuitries and one or more of egress ports 106-0 to 106-Y by interface circuitries, where X and Y are integers. Forwarding element circuitry 104 can route packets, flits, or frames of any format or in accordance with any specification from one or more of ports 102-0 to 102-X to one or more of ports 106-0 to 106-Y (or vice versa). One or more of ports 102-0 to 102-X can be connected to a network of one or more interconnected devices, including a network interface device. Similarly, one or more of ports 106-0 to 106-Y can be connected to a network of one or more interconnected devices, including a network interface device.

In some examples, switch fabric 110 can provide routing of packets from one or more ingress ports 102-0 to 102-X for processing prior to egress from forwarding element 104 via one or more of ports 106-0 to 106-Y. Switch fabric 110 can be implemented as one or more multi-hop topologies, where example topologies include torus, butterflies, buffered multi-stage, shared memory switch fabric (SMSF), among other implementations. SMSF can be a switch fabric connected to ingress ports and egress ports in the switch, where ingress subsystems write (store) packet segments into the fabric's memory, while the egress subsystems read (fetch) packet segments from the fabric's memory.

Memory 108 can be configured to store packets received at ingress ports 102-0 to 102-X prior to egress from one or more of ports 106-0 to 106-Y. Configuration 152 can set allocation of port bandwidth and queue space in memory 108 for telemetry traffic, data traffic (e.g., user data), and a mixture of telemetry and data traffic, and can control the sharing of resources between the separate networks, as described herein. In some examples, a portion of buffer space (e.g., region 150) in memory 108 and bandwidth of ports 102-0 to 102-X and 106-0 to 106-Y can be allocated to forward telemetry data and/or user data. In some examples, a queue and a port can be allocated to exclusively receive telemetry data or management commands. In some examples, a queue and a port can be allocated to receive telemetry data, management commands, and user data. In some examples, a queue and a port can be allocated to exclusively receive user data.

Packet processing pipelines 112 can include ingress and egress packet processing circuitry to respectively process ingressed packets and packets to be egressed. Packet processing pipelines 112 can determine which port to transfer packets or frames to using a table that maps packet characteristics with an associated output port. Packet processing pipelines 112 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing pipelines 112 can implement access control list (ACL) or packet drops due to queue overflow.

Packet processing pipelines 112, processors 116, and/or FPGAs 118 can process received packet data by performing one or more of: summation of packet data with other packet data from other workers, multiplication, division, minimum, maximum, or other data computation operations related to reduce, AllReduce, ReduceScatter, or AllGather. Reduce can reduce the elements of an array into a single result. AllReduce can include collecting data from different processing units and combining the data into a result. ReduceScatter can reduce input values across ranks, with each rank receiving a subpart of the result. AllGather can aggregate A values into an output of dimension A*B, where B is an integer.

Packet processing pipelines 112, processors 116, and/or FPGAs 118 can gather telemetry data from multiple sources and distribute the telemetry data to one or more controllers or management systems. Packet processing pipelines 112, processors 116, and/or FPGAs 118 can transmit updates to telemetry data from multiple sources and distribute the updates to telemetry data to one or more controllers or management systems.

Configuration of operation of packet processing pipelines 112, including its data plane, can be programmed using Programming Protocol-independent Packet Processors (P4), C, Python, Broadcom Network Programming Language (NPL), or x86 compatible executable binaries or other executable binaries.

Traffic manager 113 can perform hierarchical scheduling and transmit rate shaping and metering of packet transmissions from one or more packet queues. Traffic manager 113 can perform congestion management such as flow control, congestion notification message (CNM) generation and reception, priority flow control (PFC), and others.

In some examples, switch 100 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). In some examples, network interface device, switch, router, and/or receiver network interface device can be implemented as one or more of: one or more processors; one or more programmable packet processing pipelines; one or more accelerators; one or more application specific integrated circuits (ASICs); one or more field programmable gate arrays (FPGAs); one or more memory devices; one or more storage devices; or others. In some examples, router and switch can be used interchangeably. In some examples, a forwarding element or forwarding device can include a router and/or switch.

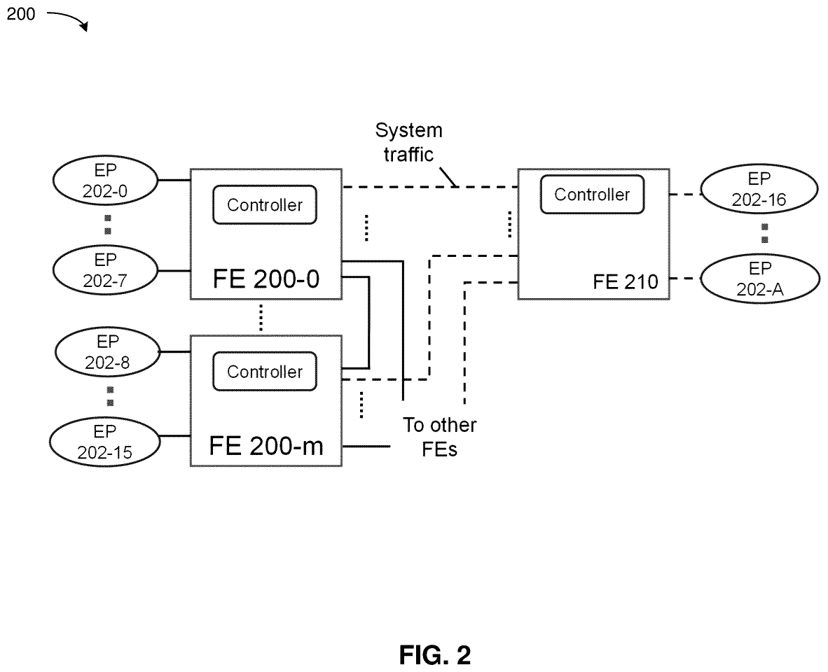

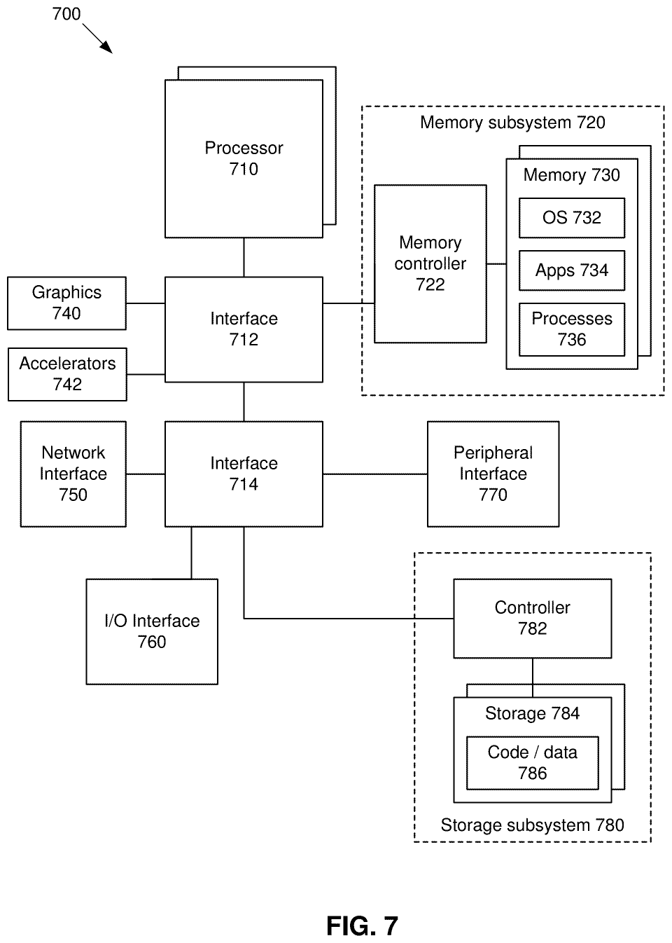

FIG. 2 depicts an example system. End points (EPs) 202-0 to 202-A can communicate by transmitting packets to ports of forwarding elements 200-0 to 200-m, where m is an integer, and ports of forwarding element 210. Various examples of end points include computer systems, such as described with respect to FIG. 7, and/or processors, memory pools, accelerators, or other devices. Forwarding elements 200-0 to 200-m and 210 can communicate using wireless signals or wired signals that transmit electrical signals and/or photonic signals.

One or more of forwarding elements 200-0 to 200-m and 210 can generate telemetry data. Telemetry data can represent operations of at least a network interface device, a processor, a memory device, an accelerator, a power supply unit, or a fabric. Telemetry data can include at least: system configuration, debug data, data from collective operations, operating status of power supply, power utilization, power supply failure, temperature alerts (e.g., over heating or too cold), forwarding element queue depth, congestion indications at a forwarding element, or others. For example, packets that carry telemetry data, management commands and system network collective packets (e.g., SysPkt) can be identified by one or more values in packet header fields.

Various examples of forwarding elements 200-0 to 200-m and 210 can provide a virtual network for telemetry data transmitted among forwarding elements 200-0 to 200-m and 210. A virtual network can provide a dedicated bandwidth in ingress and/or egress ports and buffer space for telemetry data and/or management commands. In some examples, bandwidth in ingress and/or egress ports and buffer space for telemetry data can be shared among telemetry data, management commands, and user data. User data can include payload packets that include data to be processed for a user or data that was processed for a user. The virtual network can provide a quality of service (QOS) for communications of telemetry data to reduce latency of communications of telemetry data and potentially reduce time to correct network or system issues that cause system downtime or disruptions to operations.

In some examples, communications of telemetry data can be point-to-point, by collection of individual data items through collectives, broadcast, multicast, or others. One or more collective dataflow graphs (e.g., spanning trees) can represent endpoints and a forwarding element can determine a subset of the endpoints that provide or receive specific individual telemetry data updates. One or more of forwarding elements 200-0 to 200-m and 210 can collect and/or distribute updates to telemetry data instead of transmitting collected telemetry data. For example, if a value of the telemetry data changes by more than a configured percent from a previously transmitted value of the telemetry data, then the forwarding element can transmit the telemetry data to other forwarding elements. In some examples, forwarding element 210 can provide management services for collectives by collecting and distributing telemetry data updates to other forwarding elements.

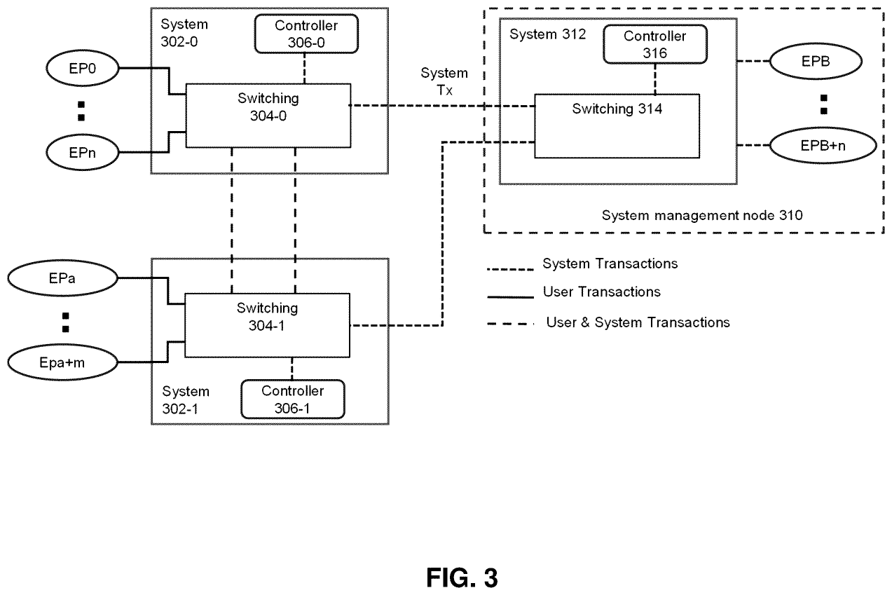

FIG. 3 depicts a system with multiple endpoints connected by forwarding elements. For example, system 302-0 can include switching circuitry 304-0 and controller 306-0. System 302-0 can be implemented as a System-on-a-Chip (SoC) or other circuitry. Similarly, system 302-1 can include switching circuitry 304-1 and controller 306-1 and can be implemented as an SoC or other circuitry. For example, switching circuitry 304-0 and/or switching circuitry 304-1 can be implemented to provide 128×128 end point switching using 16×16 routers organized as per a Fat tree network topology. However, other topologies and numbers of end point switching or routers can be used. System 302-0 can route or switch packets among EP0 to EPn. Similarly, system 302-1 can route or switch packets among EPa to EPa+m.

Management node 310 can include system 312 that provides communication among endpoints EPB to EPB+n. System 312 can include switching circuitry 314 and controller 316 and can be implemented as an SoC or other circuitry. Based on system management and telemetry data, management node 310 can manage operations of system 302-0 and 302-1 and include processors and circuitry for data processing operations. For example, managing operations of at least system 302-0 and 302-1 can include issuing management commands of at least: enter or exit specific modes of operation, increase memory allocated to store packets, decrease memory allocated to store packets, increase power supplied to one or more processor cores, decrease power supplied to one or more processor cores, increase frequency of operations of one or more processor cores, decrease frequency of operations of one or more processor cores, update firmware executed by a particular circuitry (e.g., processor, network interface device, forwarding element, memory, or other circuitry), migrate operation of a process (e.g., virtual machine (VM), container, microVM, thread, application, or other) to another processor, or other actions.

Systems 302-0 and 302-1 and 312 can provide connectivity among endpoint nodes (e.g., EP0 to EPn, EPa to Ea+m, EPB to EPB+n) according to various network topologies (e.g., HyperX, Dragonfly, or others). Physical connections can be realized using electrical or optical links and data can be transported using any protocol (e.g., Ethernet or a memory sharing protocol (e.g., Compute Express Link (CXL)). Based on configurations of controllers 306-0, 306-1, and 316, systems 302-0 and 302-1 and 312 can allocate buffer space and port bandwidth for system management and telemetry data to prioritize transmission and forwarding of system management and telemetry data.

Controllers 306-0, 306-1, and 316 can program configuration registers of respective systems 302-0, 302-1, and 312 and provide telemetry information for forwarding to one or more endpoints. Telemetry information can include at least: a heartbeat indicator (e.g., device is active), error summarization, alerts, processor performance data, power delivery state (e.g., power delivery is operational or malfunctioning), network interface device state, forwarding element congestion indicators, routing table programming, failure information such as link failure or buffer overflow, or other information. In some examples, controllers of different systems can communicate using an Out-of-Band (OOB) network. For example, controller 306-0, controller 306-1, and controller 314 can communicate using an OOB network.

In addition, a controller of a forwarding element can perform system-collective operations such as broadcast, multicast, AllReduce, and operations defined by Collective Communication Libraries (e.g., oneCCL or NVIDIA Collective Communications Library). Examples can be used where management signals are sent to forwarding elements or endpoints, for example update to the routing table. For example, controllers 306-0, 306-1, and/or 316 can, in a single operation, send a telemetry data summary to management node 310 via a collective reduction operation. For example, with an 8-byte reduction, management node 310 can receive 1 bit of state for up to 64 different partitions of the system. In some examples, management node 310, controller 306-0, and/or controller 306-1 can receive telemetry data (e.g., system transactions) and perform system management in parallel based on scalable primitives (e.g. collectives).

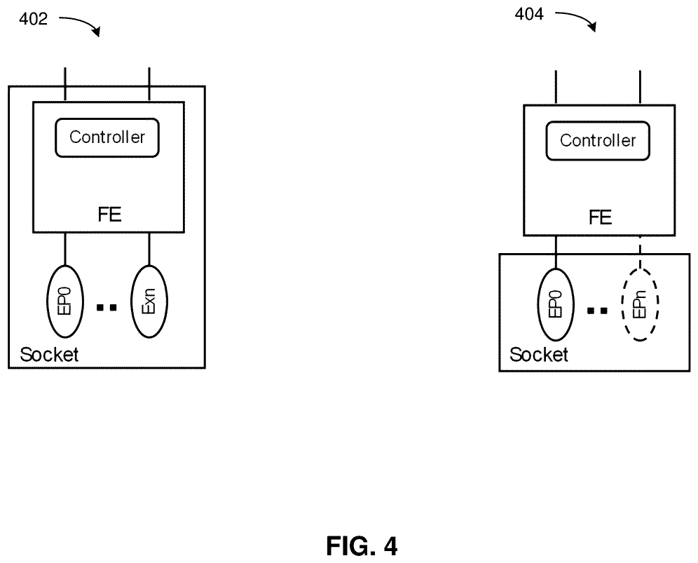

FIG. 4 depicts an example of allocations of a forwarding element to forward telemetry data. For example, configuration 402 can allocate a forwarding element to serving management nodes so that ports of the forwarding element transmit packets (e.g., telemetry data or user data) to management nodes and receive packets from management nodes (e.g., commands or user data). For example, configuration 404 can allocate a forwarding element to receive packets (e.g., telemetry data, commands, or user data) from a management node and transmit packets (e.g., telemetry data, commands, or user data) to the management node. In addition, configuration 404 can configure the forwarding element to receive packets (e.g., telemetry data, commands, or user data) from one or more end points and transmit packets (e.g., telemetry data, commands, or user data) to one or more end points. Configuration 402 can allow higher bandwidth or more frequent synchronization between management nodes compared to configuration 404. Configuration 404 can allow distribution of management nodes across more forwarding elements and potentially improve the resilience of the management system to forwarding element failures compared to configuration 402.

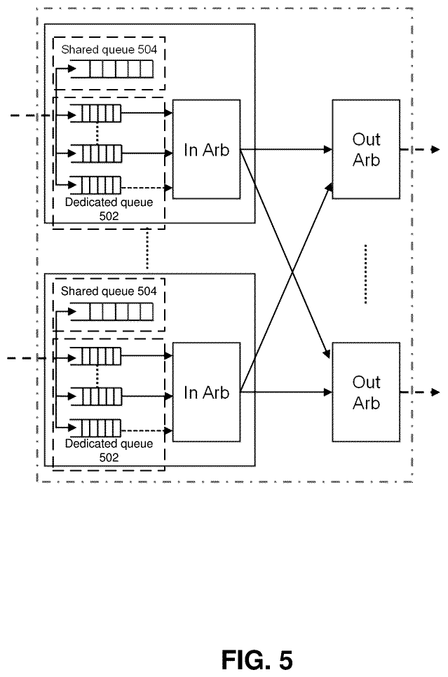

FIG. 5 depicts an example configuration of virtual channel (VC) queues of a forwarding element. As shown, queues 502 can be allocated for telemetry data (e.g., system and system-collective packets) or management commands; shared queue 504 with a mixture of telemetry data, management commands, and user data; or merely user data (not shown). Input arbitration can select from among packets in the different queues types. In some examples, if a queue stores a mixture of telemetry data, management commands, and user data, telemetry data can be egressed prior to user data and management commands can be egressed prior to user data. In some examples, arbitration to select a packet from multiple queues to egress from a port can prioritize egressing a telemetry data packet over a user packet and prioritize egressing a management command packet over a user packet.

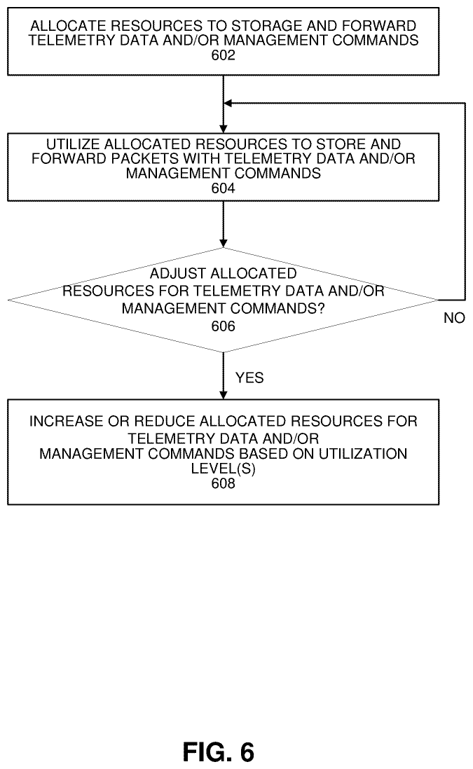

FIG. 6 depicts an example process. The process can be performed by a processor or circuitry of a forwarding element, in some examples. At 602, based on a configuration, the processor or circuitry can allocate buffer and/or port bandwidth for storage and transmission of telemetry data and/or management commands. For example, the configuration can allocate a virtual channel to transmit the telemetry data from senders (e.g., forwarding elements, compute nodes, memory pools, accelerator pools, or others) to management nodes and/or to transmit commands from management nodes to one or more controllers to adjust operations.

At 604, based on receipt of a packet with telemetry data or a command from a management node, the processor or circuitry of the forwarding element can utilize allocated ingress port bandwidth, egress port bandwidth, queue space, and/or egress packet arbitration to forward the packet. Examples of egress packet arbitration can include at least first in first out (FIFO), priority of packet to favor egress of telemetry data or management commands, round robin, weighted round robin to favor egress of telemetry data or management commands, or others.

At 606, the processor or circuitry of the forwarding element can determine whether to adjust allocated ingress port bandwidth, egress port bandwidth, queue space, and/or egress packet arbitration based on volume of received telemetry data and/or management commands in bytes or number of packets. For example, at 608, based on the volume of received telemetry data and/or management commands meeting or being less than a first level, allocated ingress port bandwidth, egress port bandwidth, and/or egress packet arbitration can be adjusted to reduce a throughput of packets with telemetry data and/or management commands and queue space can be reduced for packets with telemetry data and/or management commands. For example, at 608, based on the volume of received telemetry data and/or management commands meeting or being more than a second level, allocated ingress port bandwidth, egress port bandwidth, and/or egress packet arbitration can be adjusted to increase a throughput of packets with telemetry data and/or management commands and queue space can be increased for packets with telemetry data and/or management commands. A data center administrator or orchestrator can set the first level and the second level.

FIG. 7 depicts a system. The system can use examples to configure forwarding elements to allocate port bandwidth, egress arbitration priority, and/or queue space for telemetry data and/or management commands, as described herein. In some examples, the system can be used to perform management operations and issue management commands based on telemetry data. In some examples, processor 710, graphics 740, one or more of accelerators 742, and/or network interface 750 can decompress or decrypt data and store an entirety of decompressed or decrypted data or a strict subset of decompressed or decrypted data or validate decompression or decryption operations, described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die.

Accelerators 742 can be a fixed function or programmable offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as static random-access memory (SRAM), dynamic random-access memory (DRAM), or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 732 or driver can advertise capability of network interface 750 to allocate port bandwidth, egress arbitration priority, and/or queue space for telemetry data, as described herein. In some examples, OS 732 or driver can enable or disable network interface 750 to allocate port bandwidth, egress arbitration priority, and/or queue space for telemetry data, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. In some examples, network interface 750 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 750 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONIC), Broadcom® Network Programming Language (NPL), NVIDIA® CUDAR, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. A non-volatile memory (NVM) device is a memory whose state is determinate even if power is interrupted to the device.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: a switch system on chip (SoC), one or more tiles, or other circuitry.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a circuitry, in a forwarding element, wherein the circuitry comprises an interface to an ingress port and a second interface to an egress port and wherein the circuitry is to: receive telemetry data; cause storage of the telemetry data in a buffer; and forward the telemetry data to a network device, wherein bandwidth and buffer space in the buffer are exclusively allocated for forwarding the telemetry data and wherein the telemetry data comprises at least one of: management commands, device error reporting data, device performance data, device error data, or device debug data.

Example 2 includes one or more examples, wherein the circuitry is to exclusively allocate bandwidth to receive the telemetry data and the circuitry is to exclusively allocate bandwidth to transmit the telemetry data.

Example 3 includes one or more examples, wherein the circuitry is to allocate a queue to exclusively store telemetry data and allocate a second queue to exclusively store user data.

Example 4 includes one or more examples, and includes the forwarding element, wherein the forwarding element comprises one or more of: a switch, router, or network interface device.

Example 5 includes one or more examples, wherein the circuitry comprises a system on chip.

Example 6 includes one or more examples, and includes a network on chip (NoC), wherein the NoC comprises the forwarding element.

Example 7 includes one or more examples, wherein the device comprises one or more of: a network interface device, a processor, a memory device, an accelerator, a power supply unit, or a fabric.

Example 8 includes one or more examples, and includes a method that includes: in a forwarding element, based on a configuration, isolating transmission of telemetry data from transmission of user data from a port, wherein the telemetry data comprises at least one of: management commands, device error reporting data, device performance data, or device debug data and wherein the isolating transmission of the telemetry data comprises allocating bandwidth for the telemetry data.

Example 9 includes one or more examples, wherein the isolating transmission of telemetry data from transmission of user data comprises allocating a first level of bandwidth and a first queue to transfer the telemetry data and allocating a second level of bandwidth and a second queue to transfer the user data.

Example 10 includes one or more examples, and includes based on a second configuration, permitting transmission of second telemetry data with transmission of second user data from the port, wherein the permitting transmission of second telemetry data with transmission of second user data from the port comprises changing allocation in a queue to permit storage of the second telemetry data and the second user data.

Example 11 includes one or more examples, wherein the isolating transmission of telemetry data comprises prioritizing storage and egress of the telemetry data over storage and egress of user data.

Example 12 includes one or more examples, and includes generating the telemetry data based on multiple telemetry data.

Example 13 includes one or more examples, and includes transmitting the telemetry data to an endpoint for performing system management operations.

Example 14 includes one or more examples, wherein the forwarding element comprises one or more of: a router or a switch.

Example 15 includes one or more examples, wherein the isolating transmission of telemetry data from transmission of the user data from the port comprises transmitting the telemetry data using a virtual channel (VC) separate from a channel that transmits the user data.

Example 16 includes one or more examples, and includes at least one non-transitory computer-readable medium, comprising instructions stored thereon, that if executed by one or more processors, cause the one or more processors to: configure a forwarding element to: allocate bandwidth for transmission of telemetry data and transmission of user data from a port, wherein the telemetry data comprises at least one of: management commands, device error reporting data, device performance data, or device debug data.

Example 17 includes one or more examples, wherein the allocate bandwidth for transmission of telemetry data and transmission of user data from the port comprises allocating a first level of bandwidth and a first queue to transfer the telemetry data and allocating a second level of bandwidth and a second queue to transfer the user data.

Example 18 includes one or more examples, comprising instructions stored thereon, that if executed by one or more processors, cause the one or more processors to: based on a second configuration, permit the forwarding element to transmit second telemetry data with transmission of second user data from the port by changing allocation in a queue to permit storage of the second telemetry data and the second user data.

Example 19 includes one or more examples, wherein the allocate bandwidth for transmission of telemetry data and transmission of user data from the port comprises transmission of the telemetry data using a virtual channel (VC) separate from a channel that transmission of the user data.

Example 20 includes one or more examples, wherein the forwarding element comprises one or more of: a switch, router, or network interface device.

1. An apparatus comprising:
a circuitry, in a forwarding element, wherein the circuitry comprises an interface to an ingress port and a second interface to an egress port and wherein the circuitry is to:
receive telemetry data;
cause storage of the telemetry data in a buffer; and
forward the telemetry data to a network device, wherein bandwidth and buffer space in the buffer are exclusively allocated for forwarding the telemetry data and wherein the telemetry data comprises at least one of: management commands, device error reporting data, device performance data, device error data, or device debug data.

2. The apparatus of claim 1, wherein the circuitry is to exclusively allocate bandwidth to receive the telemetry data and the circuitry is to exclusively allocate bandwidth to transmit the telemetry data.

3. The apparatus of claim 1, wherein the circuitry is to allocate a queue to exclusively store telemetry data and allocate a second queue to exclusively store user data.

4. The apparatus of claim 1, comprising the forwarding element, wherein the forwarding element comprises one or more of: a switch, router, or network interface device.

5. The apparatus of claim 1, wherein the circuitry comprises a system on chip.

6. The apparatus of claim 1, comprising a network on chip (NoC), wherein the NoC comprises the forwarding element.

7. The apparatus of claim 1, wherein the device comprises one or more of: a network interface device, a processor, a memory device, an accelerator, a power supply unit, or a fabric.

8. A method comprising:
in a forwarding element, based on a configuration, isolating transmission of telemetry data from transmission of user data from a port, wherein the telemetry data comprises at least one of: management commands, device error reporting data, device performance data, or device debug data and wherein the isolating transmission of the telemetry data comprises allocating bandwidth for the telemetry data.

9. The method of claim 8, wherein the isolating transmission of telemetry data from transmission of user data comprises allocating a first level of bandwidth and a first queue to transfer the telemetry data and allocating a second level of bandwidth and a second queue to transfer the user data.

10. The method of claim 8, comprising:
based on a second configuration, permitting transmission of second telemetry data with transmission of second user data from the port, wherein the permitting transmission of second telemetry data with transmission of second user data from the port comprises changing allocation in a queue to permit storage of the second telemetry data and the second user data.

11. The method of claim 8, wherein the isolating transmission of telemetry data comprises prioritizing storage and egress of the telemetry data over storage and egress of user data.

12. The method of claim 8, comprising:
generating the telemetry data based on multiple telemetry data.

13. The method of claim 8, comprising:
transmitting the telemetry data to an endpoint for performing system management operations.

14. The method of claim 8, wherein the forwarding element comprises one or more of: a router or a switch.

15. The method of claim 8, wherein the isolating transmission of telemetry data from transmission of the user data from the port comprises transmitting the telemetry data using a virtual channel (VC) separate from a channel that transmits the user data.

16. At least one non-transitory computer-readable medium, comprising instructions stored thereon, that if executed by one or more processors, cause the one or more processors to:
configure a forwarding element to:
allocate bandwidth for transmission of telemetry data and transmission of user data from a port, wherein the telemetry data comprises at least one of: management commands, device error reporting data, device performance data, or device debug data.

17. The computer-readable medium of claim 16, wherein the allocate bandwidth for transmission of telemetry data and transmission of user data from the port comprises allocating a first level of bandwidth and a first queue to transfer the telemetry data and allocating a second level of bandwidth and a second queue to transfer the user data.

18. The computer-readable medium of claim 16, comprising instructions stored thereon, that if executed by one or more processors, cause the one or more processors to:
based on a second configuration, permit the forwarding element to transmit second telemetry data with transmission of second user data from the port by changing allocation in a queue to permit storage of the second telemetry data and the second user data.

19. The computer-readable medium of claim 16, wherein the allocate bandwidth for transmission of telemetry data and transmission of user data from the port comprises transmission of the telemetry data using a virtual channel (VC) separate from a channel that transmission of the user data.

20. The computer-readable medium of claim 16, wherein the forwarding element comprises one or more of: a switch, router, or network interface device.
